(19) United States
(12) Patent Application Publication
(10) Pub. No.: US 2006/0234040 A1
(43) Pub. Date: Oct. 19, 2006

(54) Patterned adhesives for color shifting effect

(76) Inventors: Yaoqi J. Liu, Shoreview, MN (US); Jeffrey H. Tokie, Scandia, MN (US); Kenneth J. Callahan, Shoreview, MN (US); Kevin R. Schaffer, Woodbury, MN (US)

Correspondence Address: 3M INNOVATIVE PROPERTIES COMPANY, PO BOX 33427, ST. PAUL, MN, 55133-3427, US

(21) Appl. No.: 11/105,969

(22) Filed: Apr. 14, 2005

(51) Int. Cl. B32B 33/00; B32B 7/12; C08J 7/04

(52) U.S. Cl. 428/343; 428/352; 428/40.1; 427/505

(57) ABSTRACT

An article is disclosed that includes a color shifting film having a film surface and an adhesive layer disposed on the color shifting film surface. The adhesive layer includes a first adhesive region having a first colorant and a second adhesive region. Methods of making and using the article are also disclosed.

### FIELD

This disclosure relates generally to film articles that incorporate information whose appearance is dependent upon viewing angle.

### BACKGROUND

Security laminates have been used to protect documents or packages to ensure that the underlying items are not altered. Security laminates are useful on identification cards such as driver's licenses and passports, and on other important documents such as certificates of title. Such laminates are also useful as protective labels on medications, videocassettes, and compact discs. Four features are useful when producing and using security laminates: (1) once applied to an article, the laminate is difficult to remove to ensure that the underlying item is not altered or subjected to tampering; (2) the laminate is difficult, if not impossible, to duplicate by counterfeiters; (3) an altered or counterfeit laminate can be quickly and accurately recognized if tampering occurs; and (4) manufacturing and application costs of the laminates are not prohibitively expensive.

Security laminates are constructed of various materials. In order to overcome the problem of counterfeit documents, manufacturers have endeavored to make it difficult for counterfeiters to duplicate a security laminate used on a particular document. Some constructions require special viewing devices to discern whether or not the laminate was subjected to tampering.

Multilayer film constructions containing intermediate layers having optical properties such as holograms or kinegrams are often used in security laminates. If the security laminate in these constructions is disturbed due to tampering, the holograms are destroyed. Tampering is therefore readily apparent when viewing the document with the naked eye. However, the film layer containing the holographic optical pattern is not transparent and can be expensive. These laminate constructions do not overcome all of the problems associated with security laminates because it is undesirable to cover an entire document or package with an opaque, expensive multilayer film. Further, it is necessary to properly register the opaque hologram on the document so as not to obscure any underlying data.

One relatively inexpensive laminate construction has been disclosed, where a document is laminated between two films with a pattern of adhesion-reducing coating either on the film or on the document before laminating. Once the layers are laminated, little or no bond exists in those places coated with the adhesion-reducing coating. Attempts to tamper with a document laminated with such a construction ordinarily result in destruction of the article to which the laminate is adhered. However, skilled tamperers are capable of removing the film without damaging the underlying article by using heat.

Tamper-proof multilayer films that are not transparent are also disclosed, wherein during attempts to tamper, the multilayer constructions are destroyed and both sides of the separated film layers display an originally concealed colored print. Tampering with these constructions is apparent to the unaided eye and the films are also impossible to laminate back together without visible damage. However, laminates having these constructions are not useful on identification documents because they are not transparent.

Other devices include constructions of a tamper-indicating labelstock or a security laminate comprising a transparent facestock, a release coating attached to one surface of the facestock for providing an indicia, a polymer coated on the facestock and release coating, a frangible metal layer and an adhesive layer. The labelstock is easily broken when tampering occurs that reveals the indicia printed by the release coating. Construction of this laminate requires a flood coating of primer over the release coating. Although this laminate might be for use as a labelstock, the laminate has relatively low durability and can split prematurely under everyday use. Further, this type of construction is susceptible to tampering because the construction is easily delaminated with heat.

### SUMMARY

This disclosure pertains generally to security articles, methods of making and methods of using the same. An article is disclosed that includes a color shifting film having a film surface and an adhesive layer disposed on the color shifting film surface. The adhesive layer includes a first adhesive region having a first colorant and a second adhesive region. In some embodiments, the first adhesive regions include a first adhesive and a first colorant and a second adhesive region includes a second adhesive, and the first adhesive and the second adhesive are different. In further embodiments, the second adhesive region further includes a second colorant and the second colorant is different from the first colorant.

Methods of making an article are also disclosed. One illustrative method includes disposing an adhesive layer on a color shifting film surface. The adhesive layer includes a first adhesive region having a first colorant and a second adhesive region. In some embodiments, the first adhesive region and second adhesive region can be formed by stripe coating, screen printing, or jet printing (e.g., ink jet printing). In some embodiments, the adhesive regions can be cured.

Methods of using an article are also disclosed. One illustrative method includes providing an adhesive layer disposed on a color shifting film and applying the adhesive layer onto a substrate. The adhesive layer includes a first adhesive region having a first colorant and a second adhesive region. The illustrative method further includes separating at least a portion of the color shifting film from at least a portion of the substrate. The separating step provides a tamper evident feature.

The above summary of the present disclosure is not intended to describe each disclosed embodiment or every implementation of the present disclosure. The Figures, Detailed Description and Examples that follow more particularly exemplify these embodiments.

### BRIEF DESCRIPTION OF THE DRAWINGS

The disclosure may be more completely understood in consideration of the following detailed description of various embodiments of the disclosure in connection with the accompanying drawings, in which:

FIG. 1 is a sectional view of an article having a color shifting film and a colored portion disposed behind the film which form indicia, the article being adhered to a substrate;

FIG. 2 is a front view of the article of FIG. 1 from a first viewing angle;

FIG. 3 is a front view of the article of FIG. 1 from a second viewing angle;

FIG. 4 is a graph of measured spectral transmission of a particular color shifting film at normal (0 degree) incidence and at 60 degrees incidence;

FIG. 5 is a schematic sectional view of an embodiment of the article of FIG. 1 being separated;

FIG. 6 is a schematic sectional view of an embodiment of the article of FIG. 1 being separated;

FIG. 7 is a schematic sectional view of an embodiment of the article of FIG. 1 being separated; and

FIG. 8 is a schematic sectional view of an embodiment of the article of FIG. 1 being separated.

While the disclosure is amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure.

### DETAILED DESCRIPTION

The following description should be read with reference to the drawings, in which like elements in different drawings are numbered in like fashion. The drawings, which are not necessarily to scale, depict selected illustrative embodiments and are not intended to limit the scope of the disclosure. Although examples of construction, dimensions, and materials are illustrated for the various elements, those skilled in the art will recognize that many of the examples provided have suitable alternatives that may be utilized.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

Weight percent, percent by weight, % by weight, wt %, and the like are synonyms that refer to the concentration of a substance as the weight of that substance divided by the weight of the composition and multiplied by 100.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. For example, reference to “an adhesive” encompass embodiments having one, two or more adhesives. As used in this specification and the appended claims, the term “or” is generally employed in its sense including “and/or” unless the content clearly dictates otherwise.

The term “indicia” refers to numbers, letters, symbols, logos, and/or shapes which may convey information.

This disclosure relates to articles with patterned adhesives having different properties and characteristics for applications such as, for example, security applications. The present disclosure implements one or more colorants into one or more adhesives and patterns the one or more adhesives. In combination with multilayer color shifting films these adhesives provide unique color shifts when viewing angles are altered. In particular, a color shifting film has a patterned adhesive on its backside and the patterned adhesive contains one or more colorants. When the viewing angle is altered, different colors and color shifts can be observed. A further aspect includes a tamper evident effect, where a film with patterned adhesives having different adhesion properties and characteristics (and optionally having different colors) when peeled from a substrate, leaves marks of the patterns on the substrate and/or the film. These effects will be described in more details below. These examples, and the examples discussed below, provide an appreciation of the applicability of the disclosed articles, but should not be interpreted in a limiting sense.

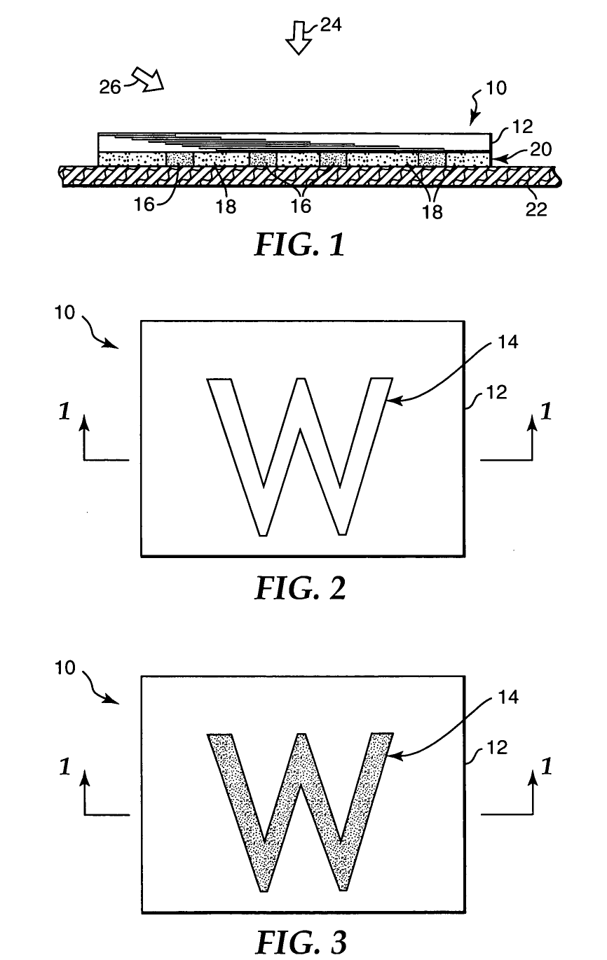

In FIG. 1, an article 10 includes an adhesive layer 20 disposed on a color shifting film 12. The article can further include a substrate 22 such that the adhesive layer 20 positioned between the color shifting film 12 and the substrate 22. The adhesive layer 20 contains a first adhesive region 16 that includes a colorant. The adhesive layer 20 further contains a second adhesive region 18. In some embodiments, the first adhesive region 16 and the second adhesive region 18 are formed of the same adhesive material. In other embodiments, the first adhesive region 16 and the second adhesive region 18 are formed of different adhesive materials. The second adhesive region 18 can optionally include a colorant that is the same as, or different than the colorant disposed within the first adhesive region 16.

The first adhesive region 16 can form a pattern and/or indicia 14 (see FIG. 2 and FIG. 3) that may be viewable through the film 12 for at least some viewing and/or illumination geometries. In some embodiments, the indicia 14 is made up of or defined by at least the first adhesive region 16 and colorant. As shown in FIGS. 1-3, portion 16 and/or 18 are patterned in complementary fashion so as to define the indicia 14, which in this embodiment is a single letter “W”. Note that FIG. 1 corresponds roughly to a sectional view taken along axis 1—1 in FIGS. 2-3, which are drawn to a somewhat smaller scale than FIG. 1.

A release liner (not shown) can be disposed on the adhesive layer 20 prior to placing the adhesive layer 20 on the color shifting film 12 and/or substrate 22. That is, the article can include a color shifting film, an adhesive layer, and a release liner with the adhesive layer positioned between the color shifting film and the release liner. Generally, a release liner includes a film capable of being placed in intimate contact with an adhesive and subsequently removed without damaging the adhesive layer. Non-limiting examples of release liners include materials from 3M of St. Paul, Minn. In some embodiments, a release liner is a polymer-coated paper with a silicone release coating, a polyethylene coated polyethylene terepthalate (PET) film with silicone release coatings, or a cast polyolefin film with a silicone release coating.

FIG. 2 illustrates that at a first viewing angle, the indicia 14 is clear and the background is clear. FIG. 3 illustrates that at a second viewing angle, the indicia 14 is colored and the background is clear. In other embodiments, both the indicia 14 and background are colored with the background color being different than the indicia color at a first or second viewing angle. In still other embodiments, the background is colored and the indicia 14 is clear at a first or second viewing angle.

The adhesive layer 20, can be formed of any useful adhesives. In some embodiments, the adhesive layer 20 includes a pressure sensitive adhesive (PSA). In further embodiments, the adhesive layer 20 includes a heat-activated or curable adhesive. The adhesive layer 20 can have any useful thickness such as, for example, 5 to 500 micrometers, or 5 to 100 micrometers, or 10 to 50 micrometers.

A first class of materials useful for the adhesive includes acrylate and methacrylate polymers and copolymers. Such polymers are formed, for example, by polymerizing one or more monomeric acrylic or methacrylic esters of non-tertiary alkyl alcohols, with the alkyl groups having from 1 to about 20 carbon atoms (e.g., from 3 to 18 carbon atoms). Suitable acrylate monomers include, for example, methyl acrylate, ethyl acrylate, n-butyl acrylate, lauryl acrylate, 2-ethylhexyl acrylate, cyclohexyl acrylate, iso-octyl acrylate, octadecyl acrylate, nonyl acrylate, decyl acrylate, and dodecyl acrylate. The corresponding methacrylates are useful as well. Also useful are aromatic acrylates and methacrylates, e.g., benzyl acrylate. Optionally, one or more monoethylenically unsaturated co-monomers may be polymerized with the acrylate or methacrylate monomers. The particular type and amount of co-monomer is selected based upon the desired properties of the polymer.

One group of useful co-monomers includes those having a homopolymer glass transition temperature greater than the glass transition temperature of the (meth)acrylate homopolymer. As used herein, the term “(meth)acrylate” refers to acrylates, methacrylates, or a combination thereof. Examples of suitable co-monomers falling within this group include acrylic acid, acrylamides, methacrylamides, substituted acrylamides (such as N,N-dimethyl acrylamide), itaconic acid, methacrylic acid, acrylonitrile, methacrylonitrile, vinyl acetate, N-vinyl pyrrolidone, isobornyl acrylate, cyano ethyl acrylate, N-vinylcaprolactam, maleic anhydride, hydroxyalkyl(meth)acrylates, N,N-dimethyl aminoethyl (meth)acrylate, N,N-diethylacrylamide, beta-carboxyethyl acrylate, vinyl esters of a carboxylic acid (e.g., carboxylic acids such as neodecanoic, neononanoic, neopentanoic, 2-ethylhexanoic, propionic acids, or the like), vinylidene chloride, styrene, vinyl toluene, and alkyl vinyl ethers.

A second group of monoethylenically unsaturated co-monomers that may be polymerized with the acrylate or methacrylate monomers includes those having a homopolymer glass transition temperature (Tg) less than the glass transition temperature of the acrylate homopolymer. Examples of suitable co-monomers falling within this class include ethyloxyethoxy ethyl acrylate (Tg equal to −71 degrees Celsius) and a methoxypolyethylene glycol 400 acrylate (Tg equal to −65 degrees Celsius) such as the material available under the trade designation NK ESTER AM-90G from Shin Nakamura Chemical Co., Ltd.

A second class of polymers useful in the adhesive includes semicrystalline polymer resins, such as polyolefins and polyolefin copolymers (e.g., polymer resins based upon monomers having between 2 to 8 carbon atoms, such as low-density polyethylene, high-density polyethylene, polypropylene, ethylene-propylene copolymers, etc.), polyesters and co-polyesters, polyamides and co-polyamides, fluorinated homopolymers and copolymers, polyalkylene oxides (e.g., polyethylene oxide and polypropylene oxide), polyvinyl alcohol, ionomers (e.g., ethylene-methacrylic acid copolymers neutralized with a base), and cellulose acetate. Other examples of polymers in this class include substantially amorphous polymers such as polyacrylonitrile, polyvinyl chloride, thermoplastic polyurethanes, general epoxies such as aromatic epoxies and/or aliphatic epoxies, polycarbonates, amorphous polyesters, amorphous polyamides, acrylonitile-butadiene-stryene (ABS) block copolymers, polyphenylene oxide alloys, ionomers (e.g., ethylene-methacrylic acid copolymers neutralized with salt), fluorinated elastomers, and polydimethyl siloxane.

A third class of polymers useful in the adhesive includes elastomers containing ultraviolet radiation-activatable groups. Examples include polybutadiene, polyisoprene, polychloroprene, random and block copolymers of styrene and dienes (e.g., SBR), and ethylene-propylene-diene monomer rubber. This class of polymer is typically combined with tackifying resins.

A fourth class of polymers useful in the adhesive includes pressure sensitive and hot melt applied adhesives prepared from non-photopolymerizable monomers. Such polymers can be adhesive polymers (i.e., polymers that are inherently adhesive), or polymers that are not inherently adhesive but are capable of forming adhesive compositions when compounded with components such as plasticizers, or tackifiers. Specific examples include poly-alpha-olefins (e.g., polyoctene, polyhexene, and atactic polypropylene), block copolymer-based adhesives, natural and synthetic rubbers, silicone adhesives, ethylene-vinyl acetate, and epoxy-containing structural adhesive blends (e.g., epoxy-acrylate and epoxy-polyester blends).

To increase cohesive strength of the adhesive, a crosslinking additive may be incorporated into the adhesive. Two main types of crosslinking additives are exemplary. The first crosslinking additive is a thermal crosslinking additive such as multifunctional aziridine, isocyanate and epoxy. One example of aziridine crosslinker is 1,1′-(1,3-phenylene dicarbonyl)-bis-(2-methylaziridine) (CAS No. 7652-64-4), referred to herein as “Bisamide.” Common polyfunctional isocyanate crosslinkers are trimethylolpropane toluene diisocyanate, toluene diisocyanate, and the like. Such chemical crosslinkers can be added into solvent-based adhesives after polymerization and activated by heat during oven drying of the coated adhesive. In another embodiment, chemical crosslinkers, which rely upon free radicals to carry out the crosslinking reaction, may be employed. Reagents such as, for example, peroxides serve as a source of free radicals. When heated sufficiently, these precursors will generate free radicals that bring about a crosslinking reaction of the polymer. A common free radical generating reagent is benzoyl peroxide. Free radical generators are required only in small quantities, but generally require higher temperatures to complete a crosslinking reaction than those required for the bisamide and isocyanate reagents.

The second type of crosslinking additive is a photosensitive crosslinker, which is activated by high intensity ultraviolet (UV) light. Two common photosensitive crosslinkers used for acrylic adhesives are benzophenone and copolymerizable aromatic ketone monomers as described in U.S. Pat. No. 4,737,559 (Kellen et al.). Another photocrosslinker, which can be post-added to the solution polymer and activated by UV light is a triazine, for example, 2,4-bis(trichloromethyl)-6-(4-methoxy-phenyl)-s-triazine. These crosslinkers are activated by UV light generated from sources such as medium pressure mercury lamps or a UV blacklight. Hydrolyzable, free-radically copolymerizable crosslinkers, such as monoethylenically unsaturated mono-, di-, and trialkoxy silane compounds including, but not limited to, methacryloxypropyltrimethoxysilane (available from Gelest, Inc., Tullytown, Pa.), vinyl dimethylethoxysilane, vinyl methyl diethoxysilane, vinyltriethoxysilane, vinyltrimethoxysilane, vinyltriphenoxysilane, and the like, are also useful crosslinking agents. Crosslinking may also be achieved using high energy electromagnetic radiation such as gamma or e-beam radiation. In this case, no crosslinker may be required.

The adhesive layer 20 can be formed by any useful method. In some embodiments, the adhesive layer 20 is formed by screen printing, stripe coating, jet printing (e.g., ink jet printing), and the like. The first adhesive region 16 can be selectively formed by screen printing, stripe coating, jet printing (e.g., ink jet printing), and the like. The second adhesive region 18 can be selectively formed by screen printing, stripe coating, jet printing (e.g., ink jet printing), and the like.

In some embodiments, the adhesive layer 20 can be disposed directly onto the multilayer color shifting film 12 surface by screen printing, stripe coating, jet printing (e.g., ink jet printing), and the like. In some of these embodiments, a release liner (not shown) can be applied to the adhesive layer 12. In other embodiments, the adhesive layer 20 can be applied to a release liner (not shown) by screen printing, stripe coating, jet printing (e.g., ink jet printing), and the like, and then the adhesive layer can be disposed onto the multilayer color shifting film 12. When present, the release liner can be removed and the adhesive layer 12 can be applied to the substrate 22.

In many embodiments, following the formation of the first adhesive region 16 and/or second adhesive region 18, the first adhesive region 16 and/or second adhesive region 18 can be cured with light or heat.

The first adhesive region 16 illustrated, is patterned to form the foreground of a letter “W”, and is disposed behind color shifting film 12. Other letters, symbols, or shapes which convey information are also contemplated. The first adhesive region 16 includes a colorant. In some embodiments, first adhesive region 16 includes a fluorescent colorant. In other embodiments, first adhesive region 16 includes a non-fluorescent colorant.

The term “colorant” refers to any pigment, dye, or other substance or combination of substances used to impart hue or chroma to an article. In some embodiments the colorant is a dye or a fluorescent. The term “fluorescent” refers to the property of emitting light at one wavelength (or band of wavelengths) as a result of the absorption of light at a different (and typically shorter) wavelength (or band of wavelengths). The wavelength range of emitted fluorescent light is referred to as an emission band; the wavelength range of the absorbed light is referred to as an excitation band.

In some embodiments, the first adhesive region 16 and the second adhesive region 18 are selectively formed by jet printing. In some embodiments, the indicia 14 is selectively formed by jet printing. Useful adhesive compositions and devices for jet printing are described in U.S. Pat. No. 5,773,485 (Bennett et al.) and U.S. Pat. No. 6,513,897 (Tokie) and U.S. Publication No., 2002/0128340 (Young et al.), all incorporated by reference herein.

The adhesive layer 20 secures the article 10 to an optional substrate 22. If desired, substrate 22 can form part of the article 10. Depending upon the intended use of the article 10, substrate 22 can itself comprise a wide variety of different articles, such as a document, sheet of paper, rigid or flexible sign backing, or rigid or flexible window material. To the extent any light is transmitted through the combination of color shifting film 12 and indicia 14, such light can be absorbed, reflected diffusely or specularly, or transmitted by substrate 22.

The color shifting film 12 has the property of transmitting different wavelengths of light as a function of the angle such light impinges on the film. The transmission properties may also be polarization dependent, even at normal incidence. In this regard, film 12 can be a polarizer, a mirror, or a mirror having substantial polarizing properties. In many embodiments, the films 12 has a multitude of alternating polymer layers arranged into a multitude of unit cells, each unit cell effective to reflect light at a wavelength twice the optical thickness of such unit cell. Such films can be made by co-extrusion of two or more polymers forming an interleaved stream of materials. The cast coextruded film can be subsequently thinned and oriented by stretching uniaxially or biaxially to form a finished reflective polarizer or mirror. In some embodiments, at least one of the polymers is capable of strain-induced birefringence so that the indices of refraction change on stretching. The unit cells, which can each include two, three, or more individual polymer layers, can also arranged to have an optical thickness gradient across the thickness of the film 12 so that a relatively wide spectral band (“reflection band”) is reflected by the film. Boundaries of the reflection band are referred to herein as band edges—spectral transitions from high reflectivity (low transmission) to low reflectivity (high transmission) or vice versa. It is also known to tailor the thickness profile of the unit cells to sharpen the band edges. These and other aspects of suitable color shifting films are described in one or more of U.S. Pat. No. 5,882,774 (Jonza et al.); U.S. Pat. No. 6,024,455 (O'Neill et al.); and U.S. Pat. No. 6,531,230 (Weber et al.), all incorporated herein by reference. Other suitable color shifting films are described, for example, in U.S. Pat. No. 5,103,337 (Schrenk et al.) (reissued as Re. 34,605) and U.S. Pat. No. 5,360,659 (Arends et al.).

Still other suitable color shifting films are inorganic multilayer films, made for example by vacuum deposition of two inorganic dielectric materials sequentially in a multitude of layers on a glass or other suitable substrate, or alternating layers of inorganic materials and organic polymers (see, e.g., U.S. Pat. No. 5,440,446 (Shaw et al.), U.S. Pat. No. 5,877,895 (Shaw et al.), and U.S. Pat. No. 6,010,751 (Shaw et al.)).

Compared to these inorganic multilayer films, polymeric films have the added benefit of being able to maintain the integrity of their band edges over substantially all incidence angles and regardless of polarization of light, by controlling the out-of-plane (z-index) index of refraction of adjacent layers within the film. In some embodiments, the difference Δn_{z} in index of refraction along the z-axis of adjacent polymer layers within a unit cell is less than the maximum index difference in the plane of the film (i.e., Δnₓ or Δn_{y}) between such adjacent layers, more preferably less than 0.5 or 0.2 times such maximum in-plane index difference, and can also be substantially zero. These conditions help maintain the shape of the band edge even as the reflection band shifts in wavelength or color with changing incidence angle, which corresponds visually to high color saturation over a wide range of incidence angles. Suitable films are available from 3M Company (St. Paul, Minn., USA) under the trade designation 3M RADIANT LIGHT FILM.

Coextruded polymeric films whose layers are not oriented, and thus are substantially isotropic in refractive index, can also be used for the color shifting film. Such films are described, for example, in U.S. Pat. No. 3,801,429 (Schrenk et al.), U.S. Pat. No. 4,162,343 (Wilcox et al.), and U.S. Pat. No. 4,310,584 (Cooper et al.)

By selection of colorant and color shifting film, light in the emission band can be substantially transmitted through the color shifting film at some angles. In some embodiments light in the emission band is substantially reflected by the color shifting film (and therefore blocked from reaching the eye of an observer) at other angles. Additionally or alternatively, if a highly directional light source is used, light in the excitation band can be blocked from reaching a fluorescent colorant at some angles but transmitted to the fluorescent colorant at other angles. Arrows 24, 26 shown in FIG. 1 represent a normal-incidence viewing angle and an oblique viewing angle respectively. At one of these angles, color shifting film 12 transmits the fluorescent emission of the first adhesive region 16, yielding a bright “W” (FIG. 3). At the other angle, color shifting film 12 may substantially block light in the emission band so that the “W” is relatively concealed (FIG. 2). The preceding discussion assumes that the fluorescent colorant in first adhesive region 16 is able to be excited by absorption of light in the excitation band. Such excitation can be achieved in a number of ways depending upon the intended application.

The color effect of a multilayer color mirror film with fluorescent and non-fluorescent colorant behind it is described in U.S. Pat. No. 6,534,158 (Huang et al.), incorporated by reference herein. Additional embodiments in which at least a first and second colored portion are disposed behind a color shifting film, such portions comprising respectively first and second different fluorescent colorants are described in U.S. Pat. No. 6,506,480 (Liu et al.), incorporated by reference herein. The first and second colored portion define indicia. The properties of the color shifting film and of the first and second fluorescent colorants are selected so that at a first angle fluorescent emission from only the first colorant is visible through the film. At a second angle, fluorescent emission from the second colorant is visible through the film. If fluorescent emission from the first colorant is not visible through the film at the second angle, a third angle may exist at which fluorescent emission from both colorants are visible through the film. A fourth angle may also exist at which fluorescent emission from neither colorant is visible through the film. By arranging the first and second colored portions as a foreground and background of the indicia, these properties can produce highly visible indicia with dramatic contrast changes as a function of angle.

In addition to what has been described above, if the complementary patterning adhesives have different adhesion properties, they can provide tamper evident features. For example, if the first adhesive has stronger adhesion to a backing (such as a color shifting film) but weaker adhesion to the substrate to be applied to, and the second adhesive has the opposite properties, when the film is peeled from the substrate, the second adhesive will be partially or completely left on the substrate while the first adhesive remains with the film.

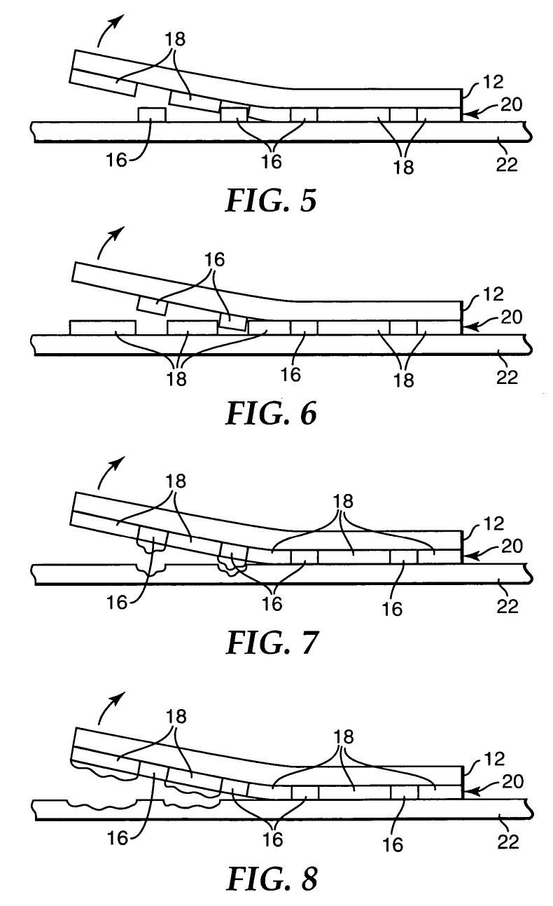

FIG. 5 through FIG. 8 are schematic sectional views of embodiments of the article of FIG. 1 being separated. In FIG. 5 through FIG. 8, an article includes an adhesive layer 20 disposed between a color shifting film 12 and a substrate 22. The adhesive layer 20 includes a first adhesive region 16 that includes a colorant and a second adhesive region 18. In this embodiment, the first adhesive region 16 and the second adhesive region 18 are formed of different adhesive materials. The second adhesive region 18 can optionally include a colorant that is the same as, or different than the colorant disposed within the first adhesive region 16.

The first adhesive region 16 has a first film peel adhesion value and a first substrate peel adhesion value. The second adhesive region 18 has a second film peel adhesion value and a second substrate peel adhesion value. The first film peel adhesion value can differ from the second film peel adhesion value by a factor or 2, 3, 4, 5, 10, 20 or more times. The first substrate peel adhesion value can differ from the second substrate peel adhesion value by a factor or 2, 3, 4, 5, 10, 20 or more times.

The adhesion value can be determined using a 180 degree peel adhesion test. This peel adhesion test is similar to the test method described in ASTM D 3330-90, substituting a glass substrate for the stainless steel substrate described in the test. The test can be performed by coating the adhesive on a substrate of interest. In some embodiments, the adhesive is coated on a polyester film. The substrate with the adhesive coating can be cut into 1.27 centimeter by 15 centimeter strips. Each strip can then be adhered to a 10 centimeter by 20 centimeter clean, solvent washed glass coupon using a 2-kilogram roller passed once over the strip. The bonded assembly can be dwelled at room temperature for about one minute and then tested for 180 degree peel adhesion using an IMASS slip/peel tester (Model 3M90, commercially available from Instrumentors Inc., Strongsville, Ohio) at a rate of 2.3 meters/minute (90 inches/minute) over a five second data collection time. Two samples are often tested; the reported peel adhesion value is an average of the peel adhesion value from each of the two samples.

In the embodiment illustrated in FIG. 5, upon separating the film 12 from the substrate 22, at least a portion of the first adhesive region 16 remains on the substrate 22 and at least a portion the second adhesive region 18 remains on the film 12, providing a tamper evident feature.

In the embodiment illustrated in FIG. 6, upon separating the film 12 from the substrate 22, at least a portion of the first adhesive region 16 remains on the film 12 and at least a portion of the second adhesive region 18 remain on the substrate 22, providing a tamper evident feature.

In the embodiment illustrated in FIG. 7, upon separating the film 12 from the substrate 22, at least a portion of the first adhesive region 16 and second adhesive region 18 remains on the film 12 and at least a portion of the substrate 22 adjacent to the first adhesive region 16 is removed from the substrate 22, providing a tamper evident feature.

In the embodiment illustrated in FIG. 8, upon separating the film 12 from the substrate 22, at least a portion of the first adhesive region 16 and second adhesive region 18 remain on the film 12 and at least a portion of the substrate 22 adjacent to the second adhesive region 18 is removed from the substrate 22, providing a tamper evident feature.

For authentication applications a film product produced with the present disclosure can have unique color shifts, tamper evident features, or a combination thereof. When the backing is a multilayer color mirror film having angular shift of colors, and the patterned adhesive(s) containing specific fluorescent (or non-fluorescent) dyes, the article provides unique color shifts changeable with viewing angle. A security label, for example, made according to this disclosure is particularly useful and provides an efficient alternative to security labels currently available for anti-counterfeiting purposes. When color shift and tamper evident features are combined by adding fluorescent dyes into adhesives having different adhesion properties to form patterns on a multilayer color mirror film backing, added security features are achieved.

This disclosure is further illustrated by the following examples that are not intended to limit the scope of the disclosure. In the examples, all parts, ratios and percentages are by weight unless otherwise indicated. All materials are commercially available, for example from Aldrich Chemicals (Milwaukee, Wis.), unless otherwise indicated or described.

### EXAMPLES

Glossary of terms

| | |
|---|---|
| IOA | Iso-octyl acrylate |
| AA | Acrylic acid |
| 2-EHA | 2-Ethylhexyl acrylate |
| PET | Polyethylene terephthalate |
| Irgacure 651 | 2,2-dimethoxy-1,2-diphenyl ethanone photoinitiator |
| | commercially available from Ciba Speciality |
| | Chemical Corp., Tarrytown, N.Y. |

### Example 1

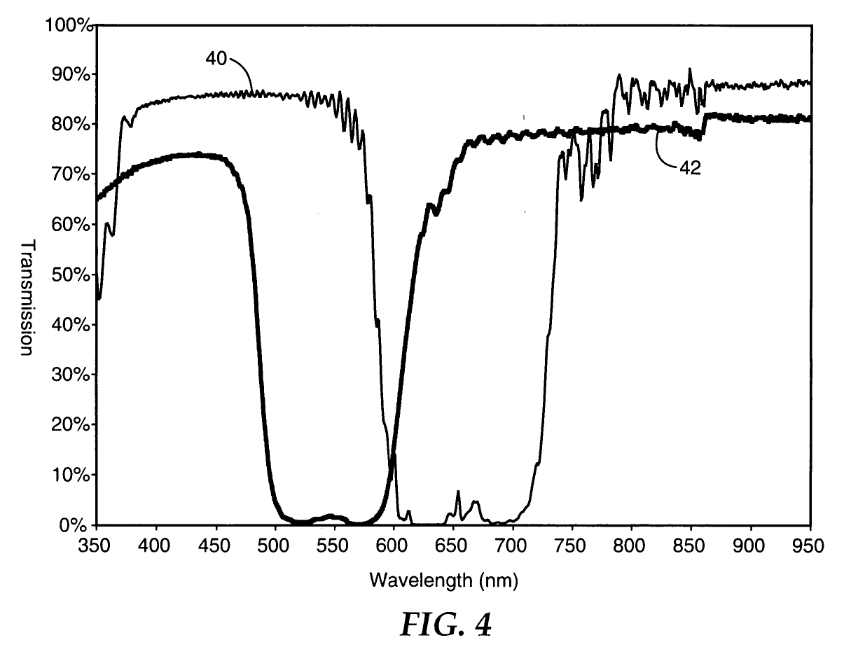

In this example, a multilayer color mirror film, Radiant Light CM590 film available from 3M is used as a backing film. The spectra at normal incidence (0 degrees) 40 and at 60 degrees 42 are shown in FIG. 4. The film changes color in transmission from cyan at normal incident (perpendicular to the film) to magenta at a shallow viewing angle.

Two adhesive monomer mixtures (Adhesive A and Adhesive B described below) were coated onto a release liner using a stripe coating die to form an ABAB pattern of 25 stripes of about 1-3 millimeters per stripe.

Adhesive A was a mixture (166.5 grams) of IOA/AA in the weight ratio of 88/12 with 0.04 wt % hexanediol diacrylate and 0.05 wt % Irgacure 651 initiator and also contained 8.24 grams of Seiko Orange Fluorescent Dye (available from Seiko).

Adhesive B contained 181.0 grams of IOA with 0.04 wt % hexanediol diacrylate and 0.05 wt % Irgacure 651 initiator and also contained 1.57 grams of 18810 Thioindigo Red dye (available from K&K Laboratories, Plainview, N.Y.).

The adhesive stripes were cured under UV light cured for 3 minutes at low intensity UV using Sylvania 350 BL lights, and the resulting adhesive stripes were transferred to a multilayer color mirror film (Radiant Light CM590 film available from 3M Company, St. Paul, Minn.) Color observations were made of the adhesive stripe coated film. At normal incident, the CM 590 appears with a cyan color. The Seiko orange dye appeared to be dark pink due to the reflection band of CM 590 blocking the emission spectra of the dye. The Thioindigo Red dye appeared dark through the film. At a shallow viewing angle (greater than about 60 degrees from normal incident), the CM 590 film appears with a magenta color. Since the reflection band of CM 590 film shifts to a lower wavelength, it is no longer blocking the emission spectra of the fluorescent orange dye, therefore, the bright orange color was now visible through the film. The Thioindigo Red dye appeared darker due to less light going through the film, although the dye absorbed some light.

### Example 2

Two adhesive monomer mixtures (Adhesive C and Adhesive D described below) were coated onto a multilayer color mirror film (Radiant Light CM590 film available from 3M Company, St. Paul, Minn.).

Adhesive C was a mixture of 2-EHA/AA in the weight ratio of 94/6 with 23% wt SiO₂ added that has a 70/30 isooctylsilane/PEG2TES blend grafted to its surface, 0.3% wt Irgacure 651 and 8% wt blaze orange dye AX-15-N (Lot #2520E available from Day-Glo Color Corporation).

“PEG2TES” refers to N-(3-triethoxysilylpropyl) methoxyethoxyethyl carbamate. It was prepared as follows: A 250 ml round- bottomed flask equipped with a magnetic stir bar was charged with diethylene glycol methyl ether (35 g) and methyl ethyl ketone (77 g). A majority of the solvent was removed via rotary evaporation to remove water. 3-(Triethoxysilyl)propylisocyanate (68.60 g) was charged to the flask. Dibutyltin dilaurate (3 mg) was added and the mixture stirred. The reaction proceeded with a mild exotherm. The reaction was run for approximately 16 hr at which time infrared spectroscopy showed no isocyanate. The remainder of the solvent and alcohol were removed via rotary evaporation (90° C.) to yield PEG2TES as a somewhat viscous fluid (104.46 g).

Adhesive D was the same as Adhesive C without the dye.

The patterned coating was carried out as follows. An inkjet system, Solidjet by Trident, an ITW Company, was used in conjunction with a motion control system and print data control system to deposit Adhesives C and D in respective patterns. The fluid supply system consists of a reservoir in fluid communication with tubing, also in fluid communication with the Trident inkjet system. All fluidic retaining devices can be heated to control viscous properties of the adhesive materials. The inkjet printhead can be fully retractable to avoid collisions with the system's platen (substrate holder). Retractability can be pneumatic or electronic by use of a linear slide mechanism. The inkjet nozzle can be coupled to a linear slide mechanism like a Trilogy linear servo motor with 42″ (1.1 meter) linear travel. The deposition velocity can be set to 3 in/s (230 mm/s) or more, or less. Any motion controller capable of controlling position and velocity can be used to control the motion. Typically, two axes are involved with printing operations to control both the print direction and the transverse or indexing directions. The motion control system triggers start of line pulses for the printhead control system to coordinate the begin of printing for each successive line of printed information—in this case adhesive C or D.

Adhesive C can be deposited in the indicia pattern, interstitial sites could be filled with Adhesive D. After each material is dispensed it is cured for 3 minutes at low intensity UV using Sylvania 350 BL lights in a nitrogen atmosphere.

Color observations were made as described for Example 1 with the same observed color effects.

### Example 3

The samples described in Example 1 were laminated to a piece of paper. When the sample was peeled from the paper, the stripes of Adhesive A tore textures from the paper, but the stripes of Adhesive B did not tear the paper.

The disclosure should not be considered limited to the particular examples described above, but rather should be understood to cover all aspects of the disclosure as set out in the attached claims. Various modifications, equivalent processes, as well as numerous structures to which the disclosure can be applicable will be readily apparent to those of skill in the art upon review of the instant specification.

What is claimed:

1. An article comprising:
a color shifting film having a film surface; and
an adhesive layer disposed on the color shifting film surface, the adhesive layer comprising a first adhesive region comprising a first colorant and a second adhesive region.

2. An article according to claim 1 wherein the first adhesive regions comprises a first adhesive and a first colorant and a second adhesive region comprising a second adhesive, wherein the first adhesive and the second adhesive are different.

3. An. article according to claim 2 wherein the second adhesive region further comprises a second colorant and the second colorant is different from the first colorant.

4. An article according to claim 1 wherein the first colorant comprises a fluorescent material.

5. An article according to claim 3 wherein the second colorant comprises a fluorescent material.

6. An article according to claim 1 wherein the first colorant comprises a fluorescent material having an emission band and the color shifting film substantially blocks transmission of light in the emission band at a first viewing angle and substantially transmits light in the emission band at a second viewing angle.

7. An article according to claim 3 wherein the second colorant comprises a fluorescent material having an emission band and the color shifting film substantially blocks transmission of light in the emission band at a first viewing angle and substantially transmits light in the emission band at a second viewing angle.

8. An article according to claim 3 wherein first colorant comprises a first fluorescent material having a first emission band and the color shifting film substantially blocks transmission of light in the first emission band at a first viewing angle and substantially transmits light in the first emission band at a second viewing angle and the second colorant comprises a second fluorescent material having a second emission band and the color shifting film substantially transmits transmission of light in the second emission band at the first viewing angle and substantially blocks light in the emission band at the second viewing angle.

9. An article according to claim 1 wherein the adhesive layer comprises a plurality of first adhesive regions comprising a first pressure sensitive adhesive.

10. An article according to claim 2 wherein the adhesive layer comprises a plurality of second adhesive regions comprising a second pressure sensitive adhesive.

11. A method of making an article comprising a step of disposing an adhesive layer on a color shifting film surface, the adhesive layer comprising a first adhesive region and a second adhesive region, wherein the first adhesive region comprises a first colorant.

12. A method according to claim 11 further comprising applying the adhesive layer on a release liner before the disposing step.

13. A method according to claim 11 wherein the disposing step comprises disposing an adhesive layer on a color shifting film surface, the adhesive layer comprising a first adhesive region comprising a first colorant and a second adhesive region comprising a second adhesive, wherein the first adhesive is different from the second adhesive.

14. A method according to claim 11 wherein the disposing step comprises stripe coating or screen printing the first adhesive region and the second adhesive region onto the color shifting film surface.

15. A method according to claim 12 wherein the applying step comprises stripe coating or screen printing the first adhesive region and the second adhesive region onto the release liner.

16. A method according to claim 11 wherein the disposing step comprises jet printing (e.g., ink jet printing) the first adhesive region and the second adhesive region onto the color shifting film surface.

17. A method according to claim 12 wherein the applying step comprises jet printing (e.g., ink jet printing) the first adhesive region and the second adhesive region onto the release liner.

18. A method according to claim 11 further comprising curing the first adhesive region and the second adhesive region.

19. A method according to claim 11 further comprising disposing a release liner on the adhesive layer.

20. A method of using an article comprising steps of:
providing an adhesive layer disposed on a color shifting film, the adhesive layer comprising a first adhesive region and a second adhesive region, wherein the first adhesive region comprises a colorant;
applying the adhesive layer onto a substrate; and
separating at least a portion of the color shifting film from at least a portion of the substrate, wherein the separating provides a tamper evident feature.

21. A method according to claim 20 wherein the providing step comprises providing an adhesive layer disposed on a color shifting film, the adhesive layer comprising a first adhesive region, comprising a first colorant, and a second adhesive region comprising a second adhesive, wherein the first adhesive is different from the second adhesive.

22. A method according to claim 21 wherein the providing step comprises providing an adhesive layer comprising a first adhesive region comprising a first adhesive and a first colorant and a second adhesive region comprising a second adhesive, wherein the first adhesive has a different adhesion to the substrate than the second adhesive; and wherein the separating step comprises separating at least a portion of the color shifting film from at least a portion of the substrate and a portion of the first or second adhesive region remains adhered to the substrate.

23. A method according to claim 21 wherein the providing step comprises providing an adhesive layer comprising a first adhesive region comprising a first adhesive and a first colorant and a second adhesive region comprising a second adhesive, wherein the first adhesive has a different adhesion to the color shifting film than the second adhesive; and wherein the separating step comprises separating at least a portion of the color shifting film from at least a portion of the substrate and a portion of the first or second adhesive region remains adhered to the color shifting film.
